(19) United States
(12) Patent Application Publication
(10) Pub. No.: US 2011/0126503 A1
(43) Pub. Date: Jun. 2, 2011

(54) Sickle Assembly

(76) Inventor: Corey Eugene Thurlow, Bengough (CA)

(21) Appl. No.: 12/950,367

(22) Filed: Nov. 19, 2010

Related U.S. Application Data
(60) Provisional application No. 61/263,135, filed on Nov. 20, 2009.

(51) Int. Cl. A01D 34/13; A01D 34/17; A01D 34/18

(52) U.S. Cl. 56/298

(57) ABSTRACT

A sickle assembly includes a cutter beam and a plurality of guard fingers fixedly mounted at spaced along positions along the cutter beam. Each guard finger includes a lower finger portion and an upper finger portion defining a sickle slot therebetween. A plurality of sickle blades on a sickle bar align with the sickle slots. The sickle blades can be positioned in a central position between adjacent guard fingers in which the sickle blade is not overlapped by either one of said adjacent ones of the guard fingers for ease of removal. In further embodiments, a hold down member is hinged relative to the cutter beam for easy access to the sickle bar. Quick release fasteners may be associated with respective pairs of sickle blades for further ease of removal and changing of sickle blades.

This application claims the benefit under 35 U.S.C. 119(e) of U.S. provisional application Ser. No. 61/263,135, filed Nov. 20, 2009.

### FIELD OF THE INVENTION

The present invention relates to various improvements to a sickle assembly of the type commonly supported on a frame of an agricultural implement for movement with the implement across the ground in a forward working direction.

### BACKGROUND

Sickle assemblies are well known for cutting crops and the like when mounted horizontally on the frame of an agricultural implement. One example of a sickle assembly is disclosed in U.S. Pat. No. 3,553,948 by White. White disclosed a typical configuration in which a plurality of guard fingers are mounted onto a horizontal cutter beam to project forwardly therefrom. A sickle bar supporting a plurality of sickle blades is mounted along side the cutter bar for reciprocation relative to the fingers. In general there are many fasteners connecting the sickle blades to the sickle bar which are inaccessible due to the surrounding guard fingers and possible hold down members also mounted with a plurality of threaded fasteners. Changing the sickle blades thus requires a very time consuming operation of removing guard fingers and hold down members to access further fasteners which require removal to remove the sickle blades.

In many other sickle assembly configurations, a portion of the guard fingers extends upwardly and rearwardly from the forward end overtop of the sickle blades to further complicate removal of the guard fingers for access to the sickle blades. The removal of the hold down members is also difficult because typically common fasteners support the hold down members and the guard fingers together so that simply removal of the hold down members causes the corresponding guard fingers to become unfastened as well. Even when access is provided to the sickle blades and sickle bar, sickle blades are typically fastened by a plurality of independent fasteners which can readily become loose and lost when separating the sickle blades from the bar. In some instances a top bar is provided above the sickle bar for clamping the sickle blades therebetween adjacent the sickle head which reciprocates the sickle bar, however removal of the top bar typically requires removal of all of the corresponding fasteners in alignment therewith which support the sickle blades to the sickle bar resulting in many loose parts which are time consuming to reassemble and which may become lost.

### SUMMARY OF THE INVENTION

According to one aspect of the invention there is provided a sickle assembly arranged to be supported on a frame for movement therewith across the ground in a forward working direction, the sickle assembly comprising:

a cutter beam arranged to be supported on the frame to span in a longitudinal direction transversely to the forward working direction;

a plurality of guard fingers fixedly mounted at spaced along positions along the cutter beam, each guard finger comprising:
a lower finger portion projecting forwardly from a rear end supported on the cutter beam to a respective free end spaced in front of the cutter beam; and
an upper finger portion projecting rearwardly from the free end of the lower finger portion to a rear end spaced above the lower finger portion so as to define a horizontally extending sickle slot therebetween which extends through the guard finger between opposing sides thereof;

a sickle bar spanning in the longitudinal direction in front of the cutter beam and above the lower finger portions of the guard fingers;

a plurality of sickle blades mounted in series with one another along the sickle bar in alignment with the sickle slots in the guard fingers, each sickle blade comprising a pair of cutting edges along opposing sides which extend inwardly and forwardly towards and central apex at a front of the sickle blade;

a sickle head coupled to one end of the sickle bar and arranged to reciprocate the sickle bar and sickle blades in the longitudinal direction relative to the cutter beam and guard fingers; and

a plurality of hold down members mounted along the cutter beam and extending forwardly over the sickle bar to a forward end overlapping a top side of the sickle blades;

the upper finger portions of adjacent ones of the guard fingers being spaced apart from one another such that a respective one of the sickle blades can be positioned in a central position between said adjacent ones of the guard fingers in which the sickle blade is not overlapped by either one of said adjacent ones of the guard fingers.

By spacing apart the upper portions of the guard fingers so as not to overlap a sickle blade centered therebetween the guard fingers are not required to be removed when replacing a sickle blade as the sickle blade is free to be lifted upwardly between the two adjacent guard fingers during replacement thereof.

Opposing sides of each upper finger portion may be tapered rearwardly and inwardly towards one another above the respective sickle slot.

Each lower finger portion may be wider below the respective sickle slot than the respective upper finger portion above the lower finger portion.

A width of each lower finger portion may correspond to at least 20% of a center to center spacing between adjacent ones of the guard fingers.

Each lower finger portion may comprise a pair of cutting edges along opposing sides of the respective sickle slot in which each cutting edge includes a protruding portion extending outwardly and rearwardly.

Each hold down member is preferably hinged on the cutter beam so as to be arranged for pivotal movement relative to the cutter beam about an axis oriented in the longitudinal direction in which each hold down member is pivotal between a working position overlapping the top side of respective ones of the sickle blades and an open position extending upwardly from the cutter beam.

There may be provided an auxiliary fastening member projecting upwardly from the cutter beam in association with each hold down member and a mating aperture in the associated hold down member arranged to receive the auxiliary fastening member therethrough in the working position. In this instance there may be provided a readily releasable retainer arranged to be selectively mounted on the auxiliary fastening member so as to retain the hold down member in the working position.

A plurality of guard members may be supported on the cutter beam in which each guard member comprises a pair of the guard fingers and is supported on the cutter beam by a pair of threaded fasteners. In this instance each hold down member preferably includes a pair of apertures arranged for receiving respective nuts of the threaded fasteners therethrough in the working position.

The plurality of hold down members are preferably hinged on a common axle extending in the longitudinal direction in which the axle is mounted in fixed relation to the cutter beam.

The forward end of each hold down member preferably includes a bottom side supporting a liner material arranged for sliding engagement with the top side of the sickle blades in which the liner material has a low coefficient of friction.

The forward end of each hold down member may include a bottom side supporting a plurality of roller members arranged for rolling engagement with the top side of the sickle blades.

The sickle blades are preferably supported on the sickle bar in pairs in which each sickle blade includes a locating aperture therein slidably receiving a mating protrusion therethrough in which the mating protrusion is fixed on the sickle bar to extend upwardly therefrom through the respective locating aperture. In this instance, there may be provided a single clamping fastener associated with each pair of sickle blades in which the single clamping fastener extends upwardly from the cutter bar between the sickle blades so as to be arranged to clamp both sickle blades of the pair of sickle blades to the cutter bar.

The mating protrusions may each comprise a threaded member which is threaded into a respective threaded aperture in the sickle bar.

There may be provided a readily releasable retainer arranged to be selectively mounted on the clamping fastener to selectively retain the pair of sickle blades between the retainer and the sickle bar.

Each pair of sickle blades may include a top plate arranged to span across the pair of sickle blades in which the top plate includes apertures arranged to receive the mating protrusions and the clamping fastener therethrough.

There may be provided at least one threaded fastener associated with each sickle blade in which the said at least one threaded fastener is threaded through the sickle bar and extends upwardly through a corresponding aperture in the sickle blade.

Each sickle blade includes at least one locating aperture therein slidably receiving a mating protrusion therethrough in which the mating protrusion is fixed on the sickle bar to extend upwardly therefrom through the respective locating aperture. In this instance there may be provided a single clamping fastener associated with each sickle blade in which the single clamping fastener extends upwardly from the cutter bar through a respective fastener aperture so as to be arranged to clamp the sickle blade to the cutter bar.

The mating protrusion preferably comprises a threaded member which is threaded into a respective threaded aperture in the sickle bar.

There may be provided a pair of locating apertures in each sickle blade in which each locating aperture is arranged to receive a mating protrusion therethrough in which the mating protrusion is fixed on the sickle bar to extend upwardly from the sickle bar through the respective locating apertures.

The clamping fastener of each sickle blade is preferably centered between the pair of locating apertures.

A top plate may be arranged to span across each sickle blade in which the top plate includes apertures arranged to receive the mating protrusion and the clamping fastener therethrough.

A top bar may span in the longitudinal direction above the sickle bar in which the top bar is fastened to the sickle bar such that some of the sickle blades adjacent the sickle head are clamped between the top bar and the sickle bar. Preferably the top bar is hinged to the sickle head for relative pivotal movement about an axis oriented generally in the forward working direction.

According to a second aspect of the present invention there is provided a sickle assembly arranged to be supported on a frame for movement therewith across the ground in a forward working direction, the sickle assembly comprising:

a cutter beam arranged to be supported on the frame to span in a longitudinal direction transversely to the forward working direction;

a plurality of guard fingers fixedly mounted at spaced along positions along the cutter beam, each guard finger comprising:
a lower finger portion projecting forwardly from a rear end supported on the cutter beam to a respective free end spaced in front of the cutter beam; and
an upper finger portion projecting rearwardly from the free end of the lower finger portion to a rear end spaced above the lower finger portion so as to define a horizontally extending sickle slot therebetween which extends through the guard finger between opposing sides thereof;

a sickle bar spanning in the longitudinal direction in front of the cutter beam and above the lower finger portions of the guard fingers;

a plurality of sickle blades mounted in series with one another along the sickle bar in alignment with the sickle slots in the guard fingers, each sickle blade comprising a pair of cutting edges along opposing sides which extend inwardly and forwardly towards and central apex at a front of the sickle blade;

a sickle head coupled to one end of the sickle bar and arranged to reciprocate the sickle bar and sickle blades in the longitudinal direction relative to the cutter beam and guard fingers; and

a plurality of hold down members mounted along the cutter beam and extending forwardly over the sickle bar to a forward end overlapping a top side of the sickle blades;

each hold down member being hinged on the cutter beam so as to be arranged for pivotal movement relative to the cutter beam about an axis oriented in the longitudinal direction; and

each hold down member being pivotal between a working position overlapping the top side of respective ones of the sickle blades and an open position extending upwardly from the cutter beam.

By further coupling the hold down members to the beam with hinges, a minimal amount of fastening is required to maintain the hold down members in their operating position so that access to the sickle blades requires a minimum number of fasteners to be released and prevents the hold down members from becoming separated from the beam even when released from their working position.

According to a third aspect of the present invention there is provided a sickle assembly arranged to be supported on a frame for movement therewith across the ground in a forward working direction, the sickle assembly comprising:

a cutter beam arranged to be supported on the frame to span in a longitudinal direction transversely to the forward working direction;

a plurality of guard fingers fixedly mounted at spaced along positions along the cutter beam, each guard finger comprising:
a lower finger portion projecting forwardly from a rear end supported on the cutter beam to a respective free end spaced in front of the cutter beam; and
an upper finger portion projecting rearwardly from the free end of the lower finger portion to a rear end spaced above the lower finger portion so as to define a horizontally extending sickle slot therebetween which extends through the guard finger between opposing sides thereof;

a sickle bar spanning in the longitudinal direction in front of the cutter beam and above the lower finger portions of the guard fingers;

a plurality of sickle blades mounted in series with one another along the sickle bar in alignment with the sickle slots in the guard fingers, each sickle blade comprising a pair of cutting edges along opposing sides which extend inwardly and forwardly towards and central apex at a front of the sickle blade;

a sickle head coupled to one end of the sickle bar and arranged to reciprocate the sickle bar and sickle blades in the longitudinal direction relative to the cutter beam and guard fingers; and

a plurality of hold down members mounted along the cutter beam and extending forwardly over the sickle bar to a forward end overlapping a top side of the sickle blades;

the sickle blades being supported on the sickle bar in pairs;

each sickle blade of each pair of sickle blades including a locating aperture therein slidably receiving a mating protrusion therethrough in which the mating protrusion is fixed on the sickle bar to extend upwardly therefrom through the respective locating aperture;

only a single clamping fastener being associated with each pair of sickle blades such that the single clamping fastener extends upwardly from the cutter bar between the sickle blades so as to be arranged to clamp both sickle blades of the pair of sickle blades to the cutter bar.

According to a fourth aspect of the present invention there is provided a sickle assembly arranged to be supported on a frame for movement therewith across the ground in a forward working direction, the sickle assembly comprising:

a cutter beam arranged to be supported on the frame to span in a longitudinal direction transversely to the forward working direction;

a plurality of guard fingers fixedly mounted at spaced along positions along the cutter beam, each guard finger comprising:
a lower finger portion projecting forwardly from a rear end supported on the cutter beam to a respective free end spaced in front of the cutter beam; and
an upper finger portion projecting rearwardly from the free end of the lower finger portion to a rear end spaced above the lower finger portion so as to define a horizontally extending sickle slot therebetween which extends through the guard finger between opposing sides thereof;

a sickle bar spanning in the longitudinal direction in front of the cutter beam and above the lower finger portions of the guard fingers;

a plurality of sickle blades mounted in series with one another along the sickle bar in alignment with the sickle slots in the guard fingers, each sickle blade comprising a pair of cutting edges along opposing sides which extend inwardly and forwardly towards and central apex at a front of the sickle blade;

a sickle head coupled to one end of the sickle bar and arranged to reciprocate the sickle bar and sickle blades in the longitudinal direction relative to the cutter beam and guard fingers; and

a plurality of hold down members mounted along the cutter beam and extending forwardly over the sickle bar to a forward end overlapping a top side of the sickle blades;

each sickle blade including at least one locating aperture therein slidably receiving a mating protrusion therethrough in which the mating protrusion is fixed on the sickle bar to extend upwardly therefrom through the respective locating aperture, and

only a single clamping fastener being associated with each sickle blade, the single clamping fastener extending upwardly from the cutter bar through a respective fastener aperture so as to be arranged to clamp the sickle blade to the cutter bar.

By providing protrusions on the sickle bar which are received through respective locating apertures in the sickle blades, a minimum number of fasteners are required to adequately support the sickle blades. For example a single bolt may be provided for each sickle blade or for each adjacent pair of sickle blades instead of multiple fasteners per sickle blade typically required in prior art configurations.

According to another aspect of the present invention there is provided a sickle assembly arranged to be supported on a frame for movement therewith across the ground in a forward working direction, the sickle assembly comprising:

a cutter beam arranged to be supported on the frame to span in a longitudinal direction transversely to the forward working direction;

a plurality of guard fingers fixedly mounted at spaced along positions along the cutter beam, each guard finger comprising:
a lower finger portion projecting forwardly from a rear end supported on the cutter beam to a respective free end spaced in front of the cutter beam; and
an upper finger portion projecting rearwardly from the free end of the lower finger portion to a rear end spaced above the lower finger portion so as to define a horizontally extending sickle slot therebetween which extends through the guard finger between opposing sides thereof;

a sickle bar spanning in the longitudinal direction in front of the cutter beam and above the lower finger portions of the guard fingers;

a plurality of sickle blades mounted in series with one another along the sickle bar in alignment with the sickle slots in the guard fingers, each sickle blade comprising a pair of cutting edges along opposing sides which extend inwardly and forwardly towards and central apex at a front of the sickle blade;

a sickle head coupled to one end of the sickle bar and arranged to reciprocate the sickle bar and sickle blades in the longitudinal direction relative to the cutter beam and guard fingers;

a plurality of hold down members mounted along the cutter beam and extending forwardly over the sickle bar to a forward end overlapping a top side of the sickle blades; and

a top bar spanning in the longitudinal direction above the sickle bar;

the top bar being fastened to the sickle bar such that some of the sickle blades adjacent the sickle head are clamped between the top bar and the sickle bar; and

the top bar being hinged to the sickle head for relative pivotal movement about an axis oriented generally in the forward working direction.

Various embodiments of the invention will now be described in conjunction with the accompanying drawings in which:

### BRIEF DESCRIPTION OF THE DRAWINGS

FIG. 1 is a schematic top plan view of a portion of the sickle assembly.

FIG. 2 is a top plan view of a first embodiment of the guard fingers.

FIG. 3 is a top plan view of a second embodiment of the guard fingers.

FIG. 4 is a top plan view of a third embodiment of the guard fingers.

FIG. 5 is a top plan view of a first embodiment of the hold down members.

FIG. 6 and FIG. 7 are respective top plan and front elevational views of a second embodiment of the hold down members.

FIG. 8 and FIG. 9 are front elevational views of third and fourth embodiments of the hold down members respectively.

FIG. 10 is a top plan view of a first embodiment of the mounting configuration of the sickle blades.

FIG. 11 is an elevational view of the mounting configuration of FIG. 10.

FIG. 12 is an elevational view of a second embodiment of the sickle blade mounting configuration.

FIG. 13 is an elevational view of a further embodiment of the sickle blade mounting.

FIG. 14 is an elevational view of another embodiment of the sickle blade mounting.

FIG. 15 is a top plan view of the mounting configuration of FIG. 14.

FIG. 16 is a top plan view of the top bar coupled to the sickle bar and sickle head.

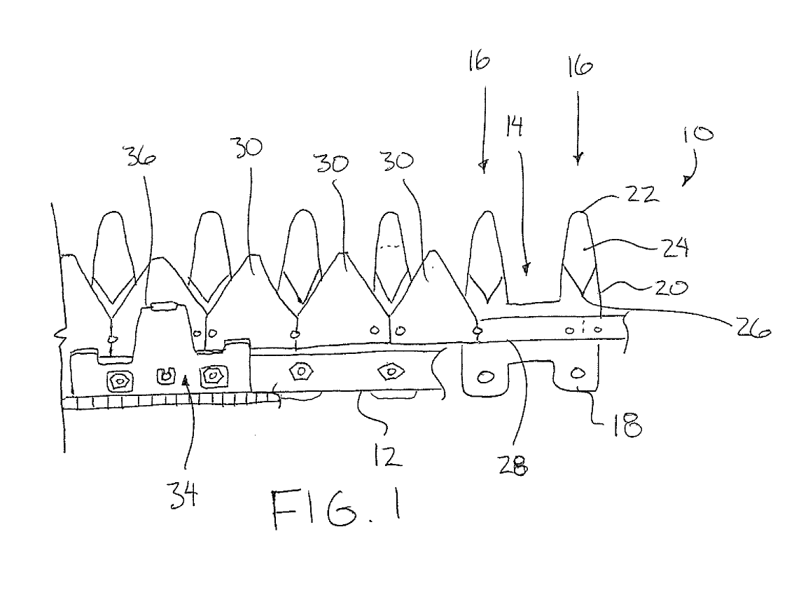

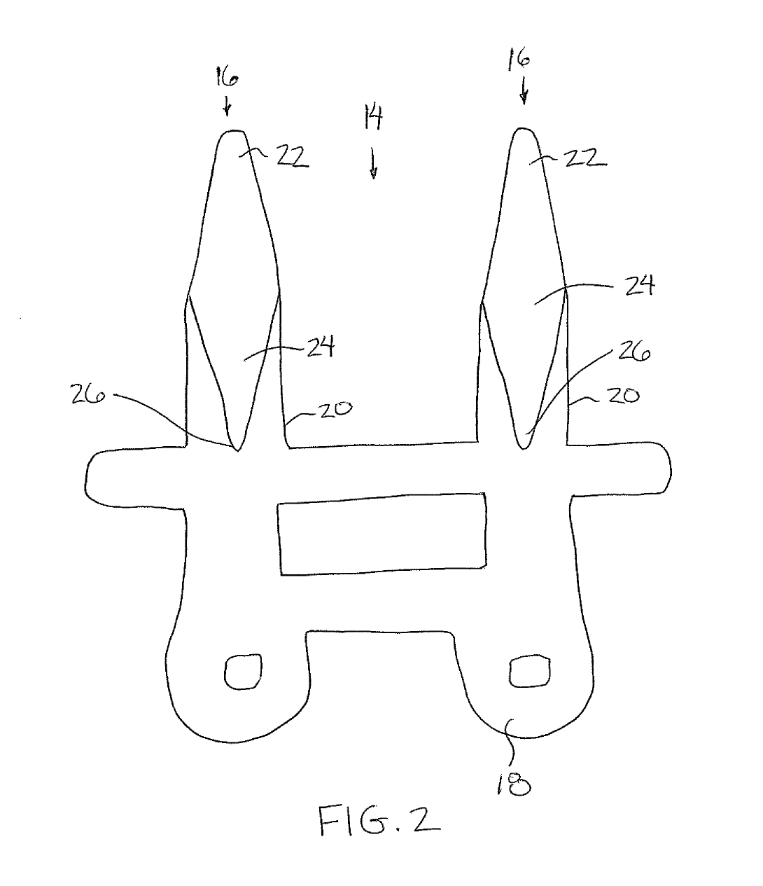

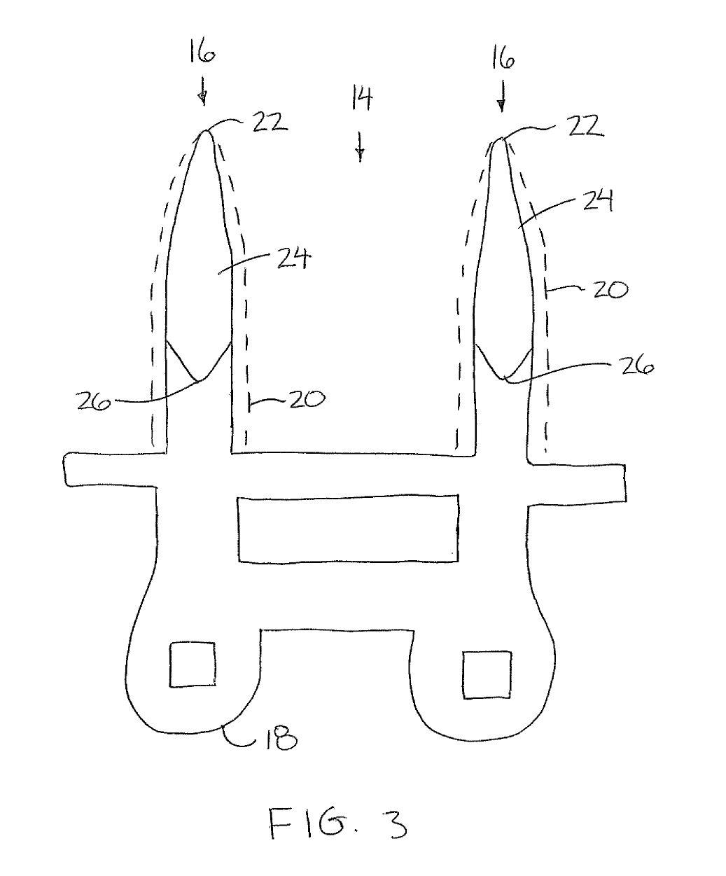

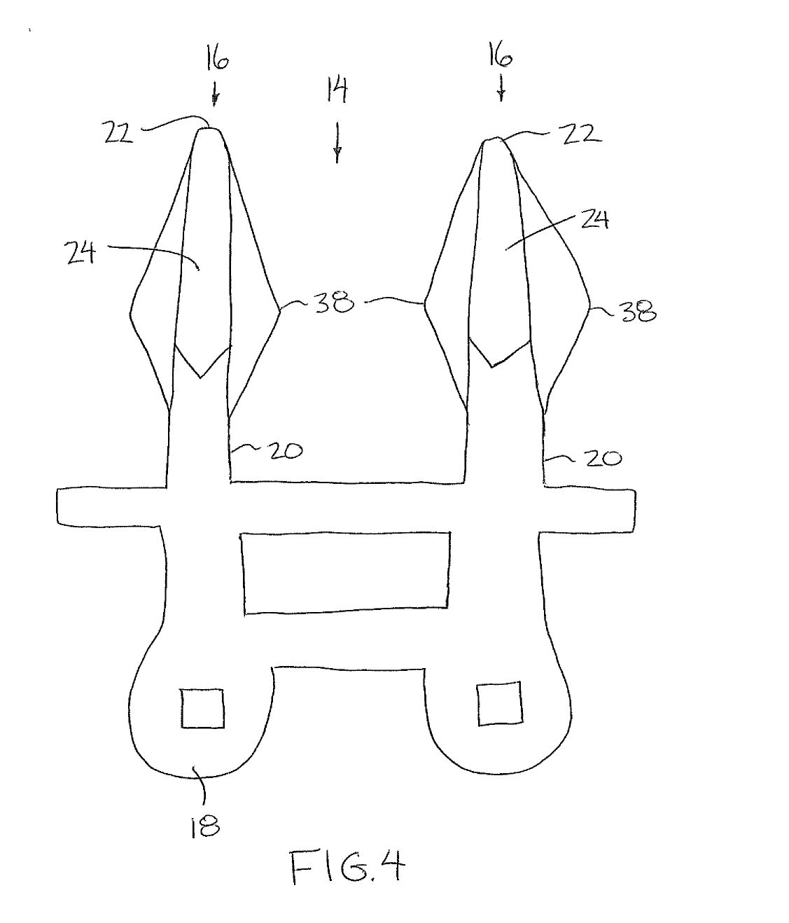

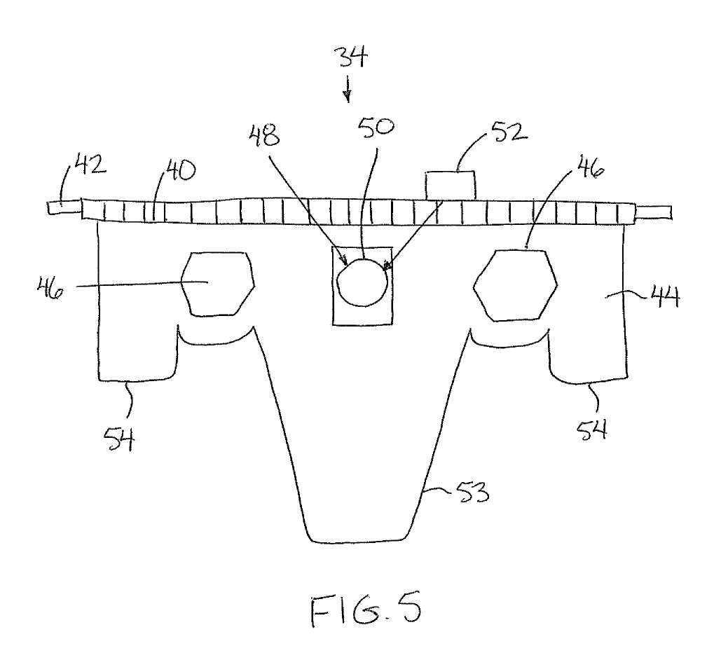

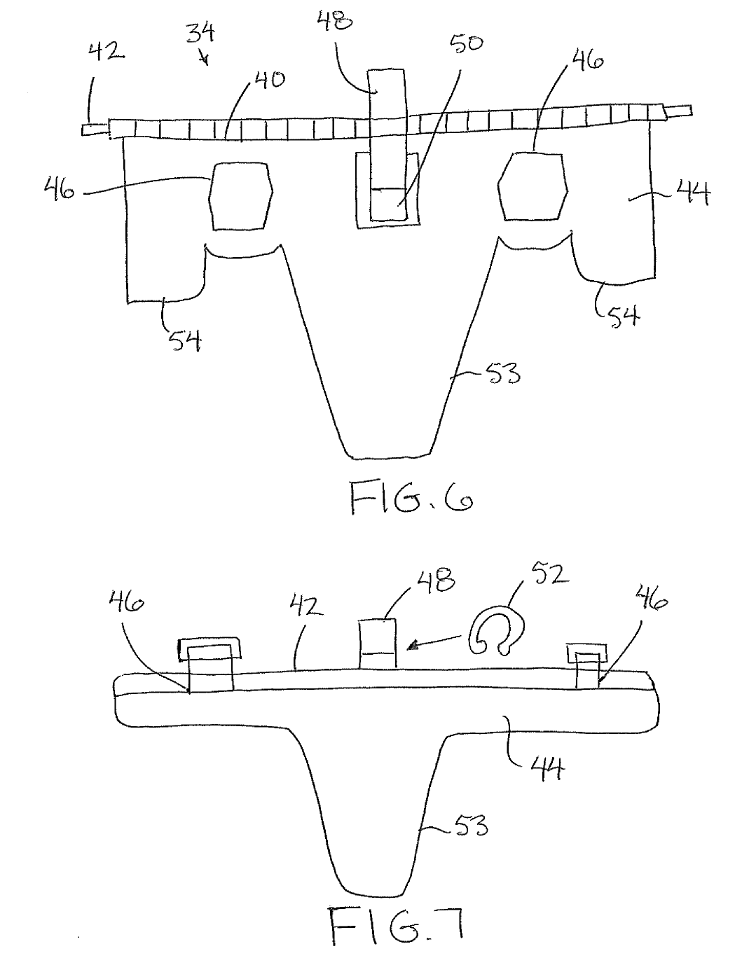

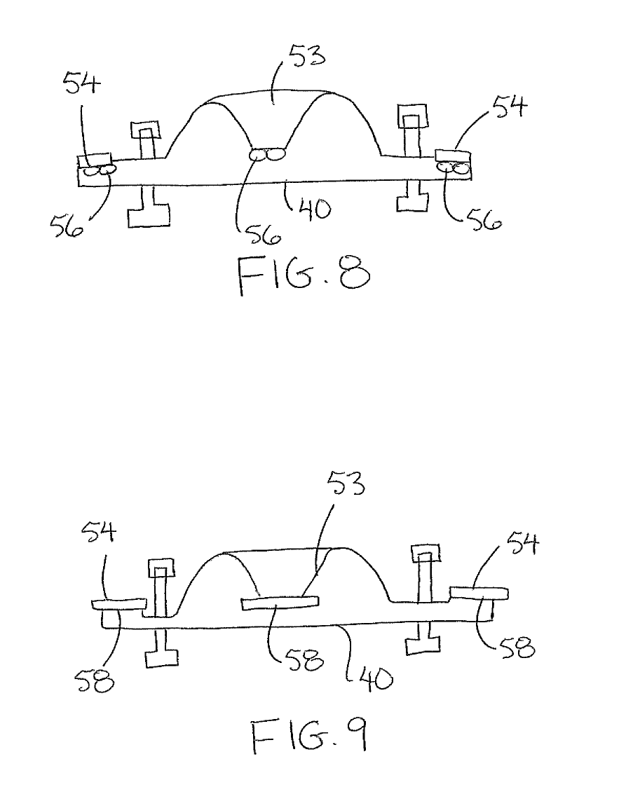

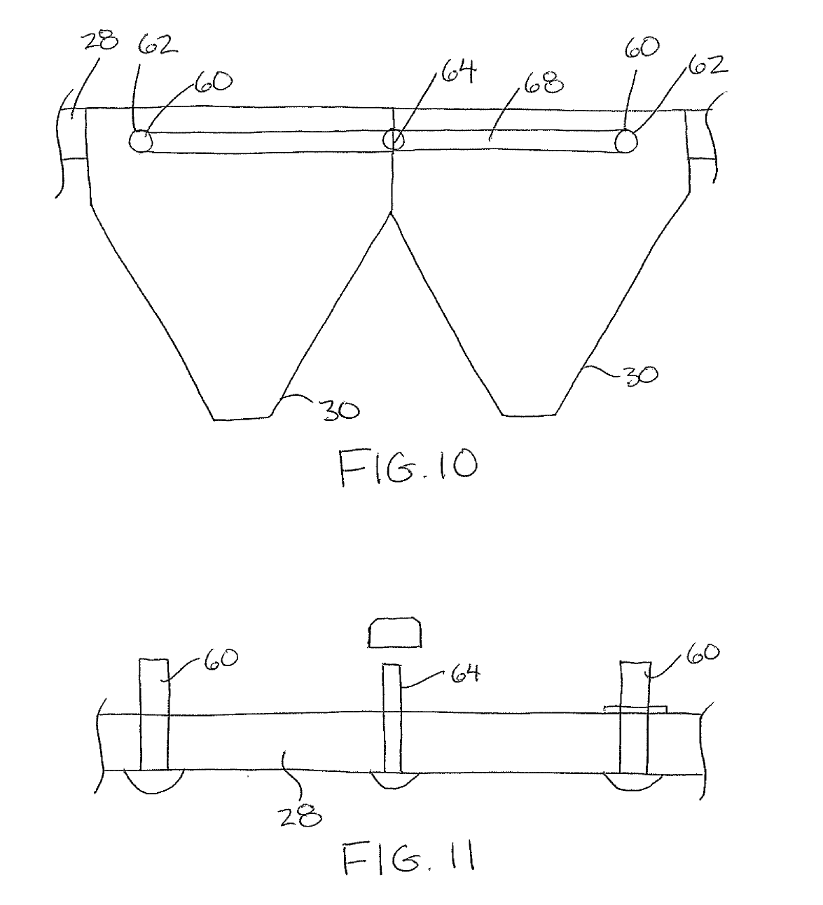

In the drawings like characters of reference indicate corresponding parts in the different figures.

### DETAILED DESCRIPTION

Referring to the accompanying figures there is illustrated a sickle assembly generally indicated by reference numeral 10. The assembly 10 is particularly suited for being mounted in a horizontal configuration on the frame of an agricultural implement for movement therewith across the ground in a forward working direction.

The sickle assembly 10 comprises a cutter beam 12 which is arranged to be fixed onto the frame to span in a longitudinal direction oriented generally perpendicularly to the forward working direction. A plurality of guard members 14 are mounted at spaced apart positions along the length of the cutter beam in fixed relation thereto. Each guard member comprises a pair of guard fingers 16 which are spaced apart in the longitudinal direction of the cutter beam such that when the guard members are mounted on the cutter beam all of the guard members 16 are evenly spaced in the longitudinal direction relative to one another.

The 2 guard fingers of each guard finger are joined at a rear end 18 supported on the cutter beam by a pair of mounting apertures which are spaced in the longitudinal direction of the cutter beam for receiving respective bolts therethrough to bolt the rear ends of the guard fingers to the underside of the beam 12 with suitable bolts. The 2 guard fingers 16 of each guard member comprise a lower finger portion 20 which projects forwardly from the rear end 18 supported on the cutter beam to a respective forward free end 22 which is spaced in front of the cutter beam and which generally narrows to an apex at the free end. The two lower finger portions 20 are joined with one another at an intermediate location by a suitable cross support as in a conventional guard member assembly.

Each guard finger 16 further comprises an upper finger portion 24 which projects upwardly and rearwardly from the free end 22 of the lower finger portion to a respective rear end 26 terminating forwardly of the beam upon which the guard fingers are mounted. The upper finger portion 24 is spaced above the lower finger portion and the rear end 26 thereof so as to define a horizontally extending sickle slot between the upper and lower finger portions. The sickle slot extends fully through the guard finger between opposing sides thereof and is open to the rear side of the upper finger portion.

The sickle assembly further comprises a sickle bar 28 which spans parallel to the cutter being in the longitudinal direction thereof at a position forward of the beam 12 and above the lower finger portions 20 of the guard fingers. Typically a channel is formed in the top side of the lower finger portions which extends in the longitudinal direction between opposing sides of the guard finger for a slidably receiving the sickle bar therein at a location rearward of the rear ends of the upper finger portions 24.

A plurality of sickle blades 30 are mounted in series with one another along the length of the sickle bar such that each of the sickle blades is abutted between an adjacent pair of sickle blades on opposing sides thereof with each of the sickle blades being fastened to the top side of the sickle bar to project generally forwardly therefrom. The sickle blade lie in a generally horizontal plane in alignment with the sickle slots in the guard fingers. Each sickle blade comprises a pair of cutting edges along opposing sides thereof which extend forwardly and inwardly towards one another to a central apex at the front end of the sickle blade in which the apex is in alignment with the forward terminal end of the sickle slot receiving the sickle blade therein.

A sickle head 32 is coupled to one end of the sickle bar so as to be arranged to reciprocate the sickle bar and sickle blades mounted thereon in the longitudinal direction relative to the cutter beam and guard fingers. The upper surface of the lower finger portion at the sickle slot is generally horizontal between opposed side edges which cooperate with the cutting edges of the sickle blades reciprocated in relation thereto to perform a cutting action therebetween.

A plurality of hold down members 34 are mounted along the top side of the cutter beam to extend forwardly over the sickle bar to respective forward ends 36 which overlap and engage a top side of the sickle blades forward of the fasteners which secure the sickle blades to the sickle bar.

Referring now more particularly to the embodiment of FIG. 2, the opposing sides of each upper finger portion 24 are arranged to taper rearwardly and inwardly towards one another above the respective sickle slot at an inclination which closely matches the inclination of the cutting edges of the sickle blades. In this manner the upper finger portions of adjacent ones of the guard fingers are sufficiently spaced apart from one another such that a respective one of these sickle blades can be positioned in a central position between the two guard fingers such that the sickle blade is not overlapped by either one of the upper finger portions of the guard fingers. More particularly the space between the upper finger portions is equal to or greater than the width of the sickle blade in the lateral direction at corresponding equal distances spaced ahead of the cutter beam 12. In this manner the guard fingers are not required to be removed in order to access and remove a sickle blade positioned between two guard fingers.

Turning now to FIG. 3, an embodiment of the guard fingers is shown in which the lower finger portion is wider in the longitudinal direction of the beam between opposing sides thereof below the sickle slot than the respective upper finger portion thereabove. More particularly each lower finger portion is wider along the full length thereof than the upper finger portion such that the upper finger portion can be arranged to not overlap a sickle blade centered therebetween while the opposing edges of the lower finger portion which interact with the cutting edges of the sickle blades interact with the sickle blades sooner than the upper finger portions to maintain a quick cutting action even with narrower upper finger portions. The width of each lower finger portion may correspond to approximately 20% of the spacing between the centers of two adjacent ones of the guard fingers.

As shown in FIG. 4, the opposing edges of the lower finger portion defining opposing side edges of the respective sickle slot function as a pair of cutting edges along opposing sides of the sickle slot which interact with the cutting edges of the sickle blade. In this instance the cutting edges of the lower finger portions include a protruding portion 38 extending outwardly and rearwardly from the forward end of the guard fingers to respective outward apexes. The protruding portions in turn extend rearwardly and inwardly from the apexes towards the intermediate location of the guard fingers where the sickle bar is located. The protruding portions of the cutting edge provide a more aggressive interactive cutting action with the cutting edges of the sickle blades. The apexes arrange to engage in overlapping configuration with the cutting edge of a corresponding one of these sickle blades prior to forward and rearward portions of the protruding portion 38 as the sickle blades are reciprocated.

Turning now to the embodiments of FIGS. 5 through 7, various embodiments of hold down members 34 are shown. In each instance the hold down member associated with each guard member is hinged along a rear edge 40 onto a common axle rod 42 extending in the longitudinal direction above the cutter beam in fixed relation thereto. Each hold down member is thus pivotal about a common axis of the axle 42 which is oriented in the longitudinal direction such that the hold down member is pivotal between a working position extending forwardly in overlapping configuration with the top sides of respective ones of the sickle blades and an open position in which the hold down members are pivoted upwardly and rearwardly away from the working position such that access to the sickle blades is unrestricted by the hold down members. The hold down members are pivotal independently of one another between the respective working and open positions thereof.

Each hold down member includes a base portion 44 adjacent a rear edge 40 which projects forwardly from the hinge rearward of the cutter beam so that the base portion 44 overlaps the cutter beam in the working position. The width of the base portion 44 corresponds approximately to the width between an adjacent pair of guard fingers of one of the guard members therebelow with which the hold down member is associated. A pair of apertures 46 are provided at longitudinally spaced positions in the base portion 44 for alignment with the pair of fasteners which bolt the corresponding guard member to the cutter bar. Accordingly the base portion 44 is arranged to lie flat against the top side of the cutter beam with the respective heads or nuts of the fasteners of the guard member extending upwardly through the apertures 46. Accordingly the apertures 46 provide access to the bolts securing the guard members to the cutter beams.

An auxiliary fastener member 48 is mounted on the cutter beam at a central location between the two threaded fasteners securing each guard member to the cutter beam in which the auxiliary fastening member projects upwardly from the cutter beam to be received through a corresponding mating aperture 50 in the hold down member centered between the apertures 46. In the working position the auxiliary fastening member 48 is arranged to receive a readily releasable container 52 thereon in the embodiments of FIGS. 6 and 7 in which the retainer comprises a snap ring or other quick release fastening mechanism which fastens by sliding or clipping connection to the free end of the fastening member 48. The retainer 52 can thus be quickly removed from the auxiliary fastening member to permit upward pivoting of the hold down member into an open position. When the retainer 52 is mounted it functions to retain the hold down member in the working position.

Alternatively as shown in FIG. 5, the auxiliary fastening member 48 may comprise a threaded bolt threaded through the beam or fixed onto the beam so that a threaded nut can be used to retain the hold down member in the working position.

In addition to the base portion 44 each hold member further comprises a central portion 53 extending forwardly from a centre of the base portion in the working position. The central portion is arced upwardly and over the row of sickle blade fasteners securing the sickle blades to the bar and tapers downwardly and inwardly towards the forward end of the central portion such that the forward end is arranged for overlapping and engaging the top side of the sickle blades therebelow in the working position.

Each hold down member further comprises two side portions 54 extending forwardly from opposing ends of the base portion in the working position. The forward ends of the two side portions 54 are located rearward of the row of fasteners securing the sickle blades to the sickle bar.

A bottom side of each of the forward ends of the central portion and the two side portions 54 is arranged for engagement with the top sides of the sickle blades in a manner which reduces friction therebetween. More particularly as shown in the embodiment of FIG. 8, a plurality of rollers 56 are provided at the forward end of the two side portions and the central portion for rolling engagement with the top side of the sickle blades. Alternatively as shown in FIG. 9, a liner material 58 is provided on the bottom of the front ends of the two side portions and the central portion for sliding engagement with the top side of the sickle blades in which the liner material has a low coefficient of friction such as neoprene and the like.

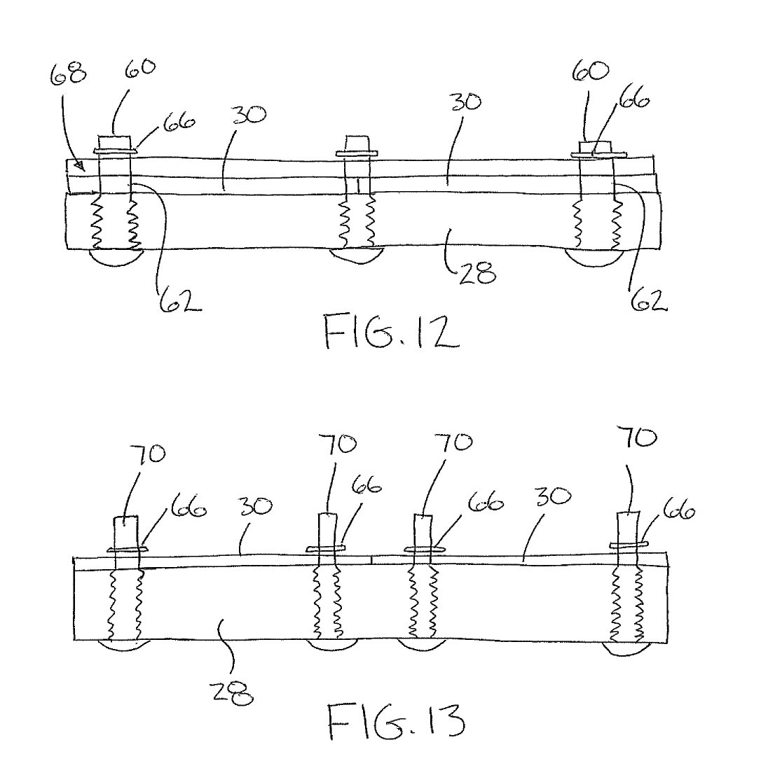

Turning now to FIGS. 10 through 12, a mounting configuration of the sickle blades is shown in which the blades are supported on the sickle bar in pairs. In this instance two fasteners 60 are provided in association with the pair of sickle blades adjacent opposing outer sides thereof to extend upwardly through the sickle bar so that the upper ends thereof define mating protrusions extending upwardly from the top side of the sickle bar through corresponding locating apertures 62 in the sickle blades adjacent the rear end thereof. The two outer fasteners define the mating protrusions 60 are fixed onto the sickle bar and remain mounted to the sickle bar when the blades are removed. This can be accomplished by threading the bolts defining the protrusions upwardly through the sickle bar as shown in FIG. 12, or alternatively the bolts may be received through corresponding apertures and retained therein by a suitable low profile nut at the topside of the sickle bar overtop which the sickle blades are mounted.

A single clamping fastener 64 is provided in each instance in the form of a threaded bolt extending upwardly through the sickle bar at the intersection where the two sickle blades of the pair are abutted with one another at a central location evenly spaced between the two fasteners forming the mating protrusions 60. A suitable recess is formed on the inner edge of each sickle blade of the pair so that the two recesses together form a suitable aperture receiving the single clamping fastener 64. As shown in FIG. 11, a threaded nut can be secured onto the upper free end of the clamping fastener 64 so that both sickle blades are arranged to be clamped by the single fastener 64 between the nut and the sickle bar. Alternatively as shown in FIG. 12 a readily releasable retainer 66 may be secured to the free end of the single clamping fastener such as a snap ring or a sliding pin and the like which is arranged to be selectively mounted onto the clamping fastener to selectively retain the pair of sickle blades between the retainer and the sickle bar.

When using a single clamping fastener 64 it is desirable to also include a top plate 68 associated with each pair of sickle blades in which the top plate spans in the longitudinal direction across the pair of sickle blades in engagement with the top side thereof so that the sickle blades are clamped between the top plate and the sickle bar. The top plate 68 includes suitable apertures at opposing ends thereof which receive the mating protrusions 60 therethrough as well as a central aperture which receives the single clamping fastener therethrough so that the top plate distributes the clamping force of the single clamping fastener 64 across the full width of the sickle blades.

In an alternative arrangement shown in FIG. 13 each sickle blade may be fastened to the sickle bar by a respective pair of fasteners 70 which are spaced apart in a longitudinal direction and which are threaded upwardly through the sickle bar. In this instance the sickle bar is much thicker than conventional sickle bars in the order of 50% greater or more than the original size. In this instance no top plate 68 is required. The upper free ends of the fasteners 70 extending upwardly through respective apertures of the sickle blades can be arranged to mount threaded nuts thereon or suitable readily releasable retainers 66 as maybe desired.

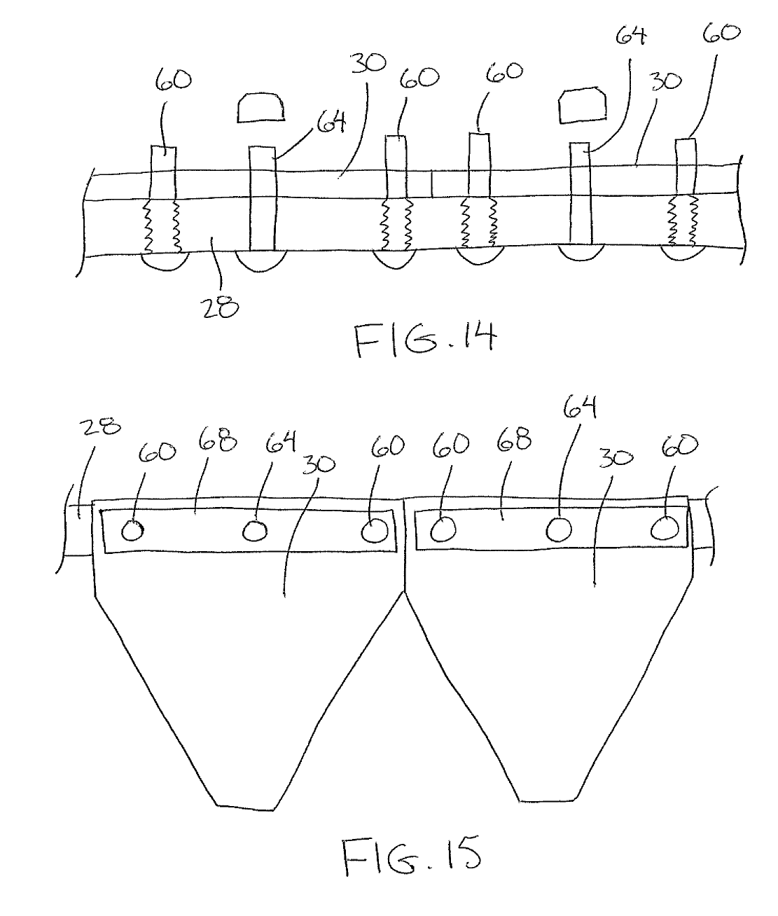

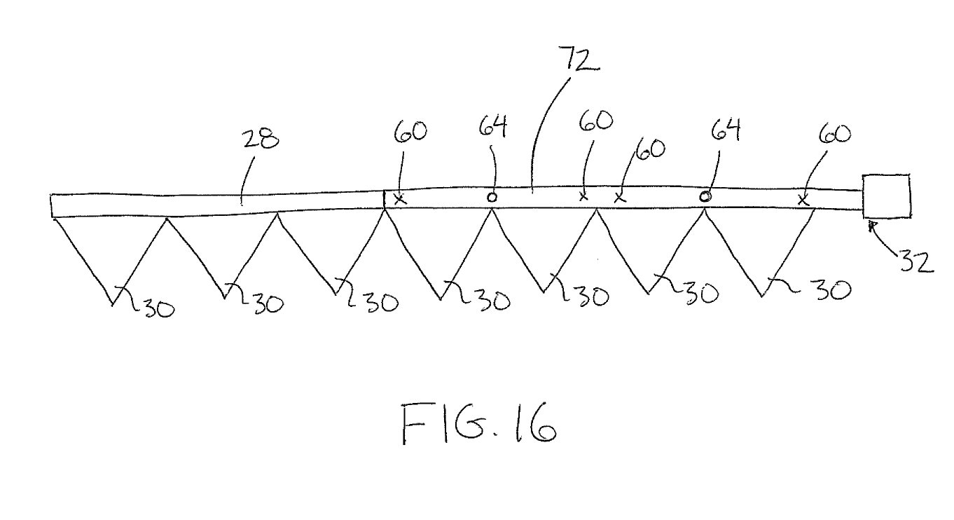

Turning now to the embodiments of FIGS. 14 and 15, mating protrusions 60 may again be provided in association with each sickle blade, however in this instance each sickle blade includes a pair of the mating protrusions 60 associated therewith at longitudinally spaced positions adjacent opposing sides of the sickle blade. Each of the protrusions 60 in this instance again similarly comprises a threaded fastener which is threaded into the sickle bar to extend upwardly therefrom through corresponding locating apertures 62 in the sickle blades. In addition to the pair of mating protrusions 60, in this instance, each sickle blade is provided with its own single clamping fastener 64 at a central locating between the two locating apertures in which the single clamping fastener is also threaded upwardly through the sickle bar for mounting a threaded nut or releasable retainer 66 on the upper ends thereof for clamping the sickle blade against the top side of the sickle bar.

A top plate 68 is also provided, however in this instance a separate plate is associated with each sickle blade to span in the longitudinal direction between opposing ends having apertures therein which receive the mating protrusions 60 therethrough. A central aperture in the top plate also receives the clamping fastener therethrough to distribute the clamping force of the nut or retainer 66 thereabove across the width of the sickle blade associated therewith.

As shown in FIG. 16, a sickle bar may also comprise a top bar 72 which spans in the longitudinal direction from the end of the sickle bar fastened to the sickle head to an opposing end at an intermediate location along the sickle bar. The top bar 72 has a length in a longitudinal direction corresponding to the width of approximately 4 to 8 sickle blades abutted in series with one another. The top bar 72 is clamped to the sickle bar with the sickle blades therebetween using the same fasteners 64 which fasten the sickle blades to the sickle bar. The top bar 72 also includes suitable apertures therein for alignment with the mating protrusions 60 extending upwardly from the sickle bar.

The top bar 72 is hinged at one end to the sickle head for relative pivotal movement therebetween about a generally horizontal axis oriented generally in the forward working direction. Accordingly when releasing the clamping fasteners 64 in connection with top bar 72, the top bar can be pivoted upward from a working position all along the topsides of the corresponding sickle blades to a released position extending generally upwardly so that access to the sickle blades is unobstructed by the top bar. In this instance the top bar can be readily released without becoming loose from the sickle assembly when replacing sickle blades while also providing structural connection between the top bar and the sickle head for extra structural connection between the sickle bar and the sickle head.

The EZEE GUARD has two inward tapered edges to allow easy sickle section replacement without removing the guard itself. The sickles are centred in between the guards by shutting down the machine and turning the sickle in the middle of the guards manually. The sickle nuts are removed and the sickle is pulled up to replace it with a new sickle. The new sickle is put into place by lowering it in between the guard and installing the sickle lock nuts.

The EZZE HOLD DOWN consists of a hinge and metal rod. The rod is welded to the harvest header to secure it in place. There is two large outside holes to accommodate going over two guard bolts. One bolt is welded to the middle to go through the hold down in the middle a lock washer and nut then secures it in place.

The EZEE SICKLE consists of one bolt and nut replacing four bolt and nuts per two sickle sections or any less than four bolts and nuts per two sickle sections. One bolt and nut hold the sickle in place while two upright bolts serve as uprights for extra support and rigidity. The top has a flat plate that helps give the two uprights tightness to hold the section down while the middle bolt and nut are tightened. The EZZE SICKLE BAR has holes aligned to accommodate the EZEE SICKLE mentioned above.

The EZEE SICKLE HEAD consists of a hinge at the beginning of the sickle head bar where the sickle drive is located. It is faster and less bothersome to replace head sickle sections due in part to the EZEE SICKLE system of less nuts and bolts plus the bar hinges for easy sickle removal without losing the strength of the cutter bar.

The EZEE ROLLER number one consists of free spinning rollers under the hold downs where the sickles rub against. It takes the friction, binding, and heat away from the sickles as they move so they run smoother operationally. The EZEE ROLLER number two consists of a stationary flat neoprene, polyurethane smooth surface under the hold down where the sickles rub against. It takes the friction binding and heat away from the sickles as they move so they run smoother operationally

The TAPERED GUARD number one consists of a tapered outer edge of the guard in a few different angles from the bottom cutting edge of the guard. It is parallel to the bottom cutting edge of the guard surface. It makes the sickles cut more quickly and efficiently.

The TAPERED GUARD number two consists of a parallel tapered outer edge to the guard. It is parallel to the bottom cutting edge of the guard. It makes the sickle cut more quickly and efficiently.

The EZEE sickle one consists of three holes in the sickle section and sickle bar. The outer two holes are for the bolts that are held in place without a nut on top by either a razor nut or threaded in the sickle bar. They serve for extra support of the sickle section. The middle bolt has a lock nut to completely fasten down the sickle section. This system makes sickle section replacement more efficient as there is only one nut to fasten down the sickle section instead of the regular two. Also it is in the middle of the section away from the guards for easier access. The system can be used with or without the use of the top flat three hole sickle plates.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A sickle assembly arranged to be supported on a frame for movement therewith across the ground in a forward working direction, the sickle assembly comprising:
a cutter beam arranged to be supported on the frame to span in a longitudinal direction transversely to the forward working direction;
a plurality of guard fingers fixedly mounted at spaced along positions along the cutter beam, each guard finger comprising:
a lower finger portion projecting forwardly from a rear end supported on the cutter beam to a respective free end spaced in front of the cutter beam; and
an upper finger portion projecting rearwardly from the free end of the lower finger portion to a rear end spaced above the lower finger portion so as to define a horizontally extending sickle slot therebetween which extends through the guard finger between opposing sides thereof;
a sickle bar spanning in the longitudinal direction in front of the cutter beam and above the lower finger portions of the guard fingers;
a plurality of sickle blades mounted in series with one another along the sickle bar in alignment with the sickle slots in the guard fingers, each sickle blade comprising a pair of cutting edges along opposing sides which extend inwardly and forwardly towards and central apex at a front of the sickle blade;
a sickle head coupled to one end of the sickle bar and arranged to reciprocate the sickle bar and sickle blades in the longitudinal direction relative to the cutter beam and guard fingers; and
a plurality of hold down members mounted along the cutter beam and extending forwardly over the sickle bar to a forward end overlapping a top side of the sickle blades;
the upper finger portions of adjacent ones of the guard fingers being spaced apart from one another such that a respective one of the sickle blades can be positioned in a central position between said adjacent ones of the guard fingers in which the sickle blade is not overlapped by either one of said adjacent ones of the guard fingers.

2. The sickle assembly according to claim 1 wherein opposing sides of each upper finger portion taper rearwardly and inwardly towards one another above the respective sickle slot.

3. The sickle assembly according to claim 1 wherein each lower finger portion is wider below the respective sickle slot than the respective upper finger portion above the lower finger portion.

4. The sickle assembly according to claim 1 wherein a width of each lower finger portion corresponds to at least 20% of a center to center spacing between adjacent ones of the guard fingers.

5. The sickle assembly according to claim 1 wherein each lower finger portion comprises a pair of cutting edges along opposing sides of the respective sickle slot, each cutting edge including a protruding portion extending outwardly and rearwardly.

6. The sickle assembly according to claim 1 wherein each hold down member is hinged on the cutter beam so as to be arranged for pivotal movement relative to the cutter beam about an axis oriented in the longitudinal direction, each hold down member being pivotal between a working position overlapping the top side of respective ones of the sickle blades and an open position extending upwardly from the cutter beam.

7. The sickle assembly according to claim 6 wherein there is provided an auxiliary fastening member projecting upwardly from the cutter beam in association with each hold down member and a mating aperture in the associated hold down member arranged to receive the auxiliary fastening member therethrough in the working position, and wherein there is provided a readily releasable retainer arranged to be selectively mounted on the auxiliary fastening member so as to retain the hold down member in the working position.

8. The sickle assembly according to claim 6 wherein there is provided a plurality of guard members supported on the cutter beam in which each guard member comprises a pair of the guard fingers and is supported on the cutter beam by a pair of threaded fasteners, each hold down member including a pair of apertures arranged for receiving respective nuts of the threaded fasteners therethrough in the working position.

9. (canceled)

10. The sickle assembly according to claim 1 wherein the forward end of each hold down member includes a bottom side supporting a liner material arranged for sliding engagement with the top side of the sickle blades, the liner material having a low coefficient of friction.

11. The sickle assembly according to claim 1 wherein the forward end of each hold down member includes a bottom side supporting a plurality of roller members arranged for rolling engagement with the top side of the sickle blades.

12. The sickle assembly according to claim 1 wherein the sickle blades are supported on the sickle bar in pairs, each sickle blade including a locating aperture therein slidably receiving a mating protrusion therethrough in which the mating protrusion is fixed on the sickle bar to extend upwardly therefrom through the respective locating aperture, and wherein there is provided a single clamping fastener associated with each pair of sickle blades, the single clamping fastener extending upwardly from the cutter bar between the sickle blades so as to be arranged to clamp both sickle blades of the pair of sickle blades to the cutter bar.

13. The sickle assembly according to claim 12 wherein the mating protrusions each comprise a threaded member which is threaded into a respective threaded aperture in the sickle bar.

14. The sickle assembly according to claim 12 wherein there is provided a readily releasable retainer arranged to be selectively mounted on the clamping fastener to selectively retain the pair of sickle blades between the retainer and the sickle bar.

15. The sickle assembly according to claim 12 wherein each pair of sickle blades includes a top plate arranged to span across the pair of sickle blades, the top plate including apertures arranged to receive the mating protrusions and the clamping fastener therethrough.

16. The sickle assembly according to claim 1 wherein there is provided at least one threaded fastener associated with each sickle blade in which the said at least one threaded fastener is threaded through the sickle bar and extends upwardly through a corresponding aperture in the sickle blade.

17. The sickle assembly according to claim 1 wherein each sickle blade includes at least one locating aperture therein slidably receiving a mating protrusion therethrough in which the mating protrusion is fixed on the sickle bar to extend upwardly therefrom through the respective locating aperture, and wherein there is provided a single clamping fastener associated with each sickle blade, the single clamping fastener extending upwardly from the cutter bar through a respective fastener aperture so as to be arranged to clamp the sickle blade to the cutter bar.

18. The sickle assembly according to claim 17 wherein the mating protrusion comprises a threaded member which is threaded into a respective threaded aperture in the sickle bar.

19. The sickle assembly according to claim 17 wherein there is provided a pair of locating apertures in each sickle blade in which each locating aperture is arranged to receive a mating protrusion therethrough in which the mating protrusion is fixed on the sickle bar to extend upwardly from the sickle bar through the respective locating apertures.

20. (canceled)

21. The sickle assembly according to claim 17 wherein there is provided a top plate arranged to span across each sickle blade, the top plate including apertures arranged to receive the mating protrusion and the clamping fastener therethrough.

22. The sickle assembly according to claim 1 wherein there is provided a top bar spanning in the longitudinal direction above the sickle bar, the top bar being fastened to the sickle bar such that some of the sickle blades adjacent the sickle head are clamped between the top bar and the sickle bar, and the top bar being hinged to the sickle head for relative pivotal movement about an axis oriented generally in the forward working direction.
